(19) United States
(12) Patent Application Publication
(10) Pub. No.: US 2026/0042326 A1
(43) Pub. Date: Feb. 12, 2026

(54) LOOP BRIDGE TRAILER SECURING SYSTEM

(71) Applicant: Delbert Shields, Humbolt, KS (US)

(72) Inventor: Delbert Shields, Humbolt, KS (US)

(21) Appl. No.: 19/291,397

(22) Filed: Aug. 5, 2025

Related U.S. Application Data
(60) Provisional application No. 63/680,734, filed on Aug. 8, 2024.

(51) Int. Cl. B60D 1/18; B60D 1/52; B60D 1/58

(52) U.S. Cl. CPC B60D 1/187; B60D 1/52; B60D 1/583

(57) ABSTRACT

A loop bridge trailer securing system for facilitating the secure attachment, removal, and reattachment of safety chains while securing trailer masts to truck beds. The system includes a safety chain assembly, a trailer mast anchor functioning as a loop bridge device, and a grabber handling tool. The grabber handling tool comprises a metal tube structure with a spring-loaded grabber at one end, an adjacent perpendicular member with parallel elevated tracks, and a locking pin mechanism. The trailer mast anchor elevates a spring-loaded loop in the truck bed, allowing for easier insertion of chain hooks. The system enables users to perform safety chain operations from ground level, eliminating the need to climb into the truck bed and enhancing both safety and efficiency during trailer securing procedures.

### RELATED APPLICATIONS

This application claims the benefit of U.S. Provisional Patent Application No. 63/680,734, filed Aug. 8, 2024, the entire contents of which are hereby incorporated by reference herein.

### FIELD OF THE INVENTION

The present disclosure relates generally to trailer securing systems. More particularly, embodiments of the present disclosure relate to systems and methods for securing trailers to towing vehicles through safety chains. The embodiments described herein may be applicable to various fields including, but not limited to, vehicle towing systems, trailer hitches, safety chain management, and ground-level trailer securing operations.

### BACKGROUND OF THE INVENTION

Conventional trailer securing systems typically require an operator to climb into the truck bed to attach, detach, or reattach safety chains between a towing vehicle and a trailer. This process can be cumbersome, physically demanding, and potentially hazardous, particularly for individuals with limited mobility or in adverse weather conditions. Traditional systems often include fixed hooks in the truck bed for chain attachment, which provides limited flexibility and may not accommodate all types of safety chains.

The physical demands of climbing into a truck bed to manipulate safety chains can lead to strain injuries or accidents. Additionally, the time-consuming nature of this process reduces operational efficiency during trailer connection and disconnection procedures. Furthermore, existing systems may not provide adequate tension maintenance during chain manipulation, potentially compromising safety during towing operations.

Therefore, there exists a need for an improved trailer securing system that allows users to perform safety chain operations from ground level, eliminates the need to climb into the truck bed, and enhances both safety and efficiency during trailer securing procedures.

### SUMMARY OF THE INVENTION

The present disclosure provides a loop bridge trailer securing system that addresses the limitations of conventional trailer securing systems. Embodiments of the present disclosure may allow users to securely attach, remove, and reattach safety chains while securing trailer masts to truck beds without climbing into the truck bed.

In accordance with the principles of the present invention, a loop bridge trailer securing system is provided. The loop bridge trailer securing system may comprise a safety chain anchor, a trailer mast anchor, and a grabber handling tool. The loop bridge trailer securing system is an innovative system designed to facilitate the secure attachment, removal, and reattachment of safety chains while securing the trailer mast and safety chains to the bed of trucks pulling RVs or trailers. By allowing users to perform these operations from ground level, it eliminates the need for climbing into the truck bed during the process. The grabber handling tool features a metal tube with a spring-loaded handle for efficient chain hook manipulation. Such aspects and elements also includes improvements that overcome the limitations of prior art attachment members is now met by a new, useful, and non-obvious invention.

In accordance with the purposes of the invention, as embodied and broadly described herein, the invention, in one aspect, relates to a loop bridge trailer securing system. In one or more aspects, the Loop bridge trailer securing system may combine practical design with innovative features, addressing the limitations of prior art while ensuring user-friendly safety chain handling. In yet another aspect, the Loop bridge trailer securing system provides a safety chain handling device designed for trucks pulling RVs or trailers. The Loop bridge trailer securing system is configured to allow users to securely attach, remove, and reattach safety chains from ground level, eliminating the need to climb into the truck bed.

In one or more aspects, the Loop bridge trailer securing system features a metal tube structure with a spring-loaded handle for chain hook manipulation. In one aspect, the Loop bridge trailer securing system provides for a strategically positioned middle pin that maintains tension during operations, enhancing safety and efficiency.

In one aspect, a loop bridge trailer securing system may comprise a safety chain assembly, a trailer mast anchor that functions as a loop bridge device, and a grabber handling tool. The grabber handling tool may include a metal tube structure with a spring-loaded grabber at one end, an adjacent perpendicular member with parallel elevated tracks, and a locking pin mechanism configured to maintain tension during chain manipulation. In another aspect, the trailer mast anchor may be designed to elevate a spring-loaded loop in the truck bed, allowing for easier insertion of chain hooks. The trailer mast anchor may be available in different designs to accommodate various truck bed configurations and trailer hitch types. In yet another aspect, the grabber handling tool may be configured for one-handed operation, enhancing user convenience while preventing accidental release or slackening of safety chains during manipulation.

These and other features, aspects, and advantages of the present disclosure will become better understood with reference to the following description and appended claims. The accompanying drawings, which are incorporated in and constitute a part of this specification, illustrate embodiments of the disclosure and, together with the description, serve to explain the principles of the disclosure.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several aspects of the invention and together with the description, serve to explain the principles of the invention. A full and enabling disclosure of the present invention, including the best mode thereof, directed to one of ordinary skill in the art, is set forth in the specification, which makes reference to the appended figures, in which:

FIG. 1 shows an embodiment of a grabber handling tool of a loop bridge trailer securing system in accordance with aspects of the present disclosure.

FIG. 2 shows the grabber handling tool secured to a trailer mast anchor in accordance with aspects of the present disclosure.

FIG. 3 shows an embodiment of the grabber handling tool with a depressed spring-loaded grabber in accordance with aspects of the present disclosure.

FIG. 4 shows the grabber handling tool in operation connected to a portion of a safety chain and cable in accordance with aspects of the present disclosure.

FIG. 5 shows an embodiment of the complete loop bridge trailer securing system including a safety chain assembly, a trailer mast anchor on a vehicle hitch, a safety chain grabber tool, and a truck bed in accordance with aspects of the present disclosure.

Repeat use of reference characters in the present specification and drawings is intended to represent the same or analogous features or elements of the present disclosure. The drawings are not necessarily to scale and certain features and certain views of the figures may be shown exaggerated, to scale or in schematic in the interest of clarity and conciseness. Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION OF THE INVENTION

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

As used in the specification and the appended claims, the singular forms “a,” “an,” and “the” include plural referents unless the context clearly dictates otherwise. The terms “comprising,” “including,” “containing,” “characterized by,” and grammatical equivalents thereof are inclusive or open-ended terms that do not exclude additional, unrecited elements or method steps.

The present disclosure relates to a loop bridge trailer securing system designed to facilitate the secure attachment, removal, and reattachment of safety chains while securing trailer masts to truck beds. The system may be particularly useful for trucks pulling recreational vehicles (RVs) or trailers. By allowing users to perform these operations from ground level, the system eliminates the need for climbing into the truck bed during the process.

The present invention can be understood more readily by reference to the following detailed description of the invention and the Examples included therein.

Before the present articles, systems, devices, and/or methods are disclosed and described, it is to be understood that they are not limited to specific manufacturing methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

### Definitions

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this present disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “an opening” can include two or more openings.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

Disclosed are the components to be used to manufacture the disclosed devices, systems, and articles of the present disclosure as well as the devices themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and devices of the present disclosure. Thus, if there are a variety of additional steps that can be performed it is understood that each of these additional steps can be performed with any specific aspect or combination of aspects of the methods of the present disclosure.

It is understood that the devices and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

All publications mentioned herein are incorporated herein by reference to disclose and describe the methods and/or materials in connection with which the publications are cited.

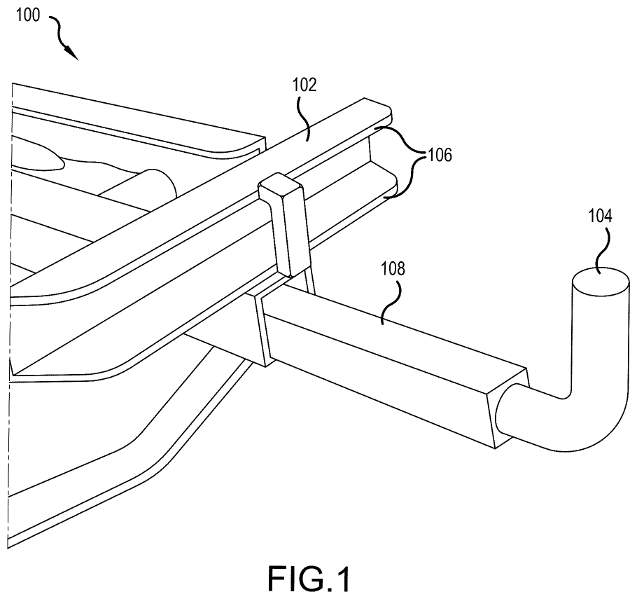

Regarding FIGS. 1-5, they each illustrate an exemplary loop bridge trailer securing system in accordance with the teachings of this invention. A loop bridge trailer securing system may comprise a safety chain assembly, a trailer mast anchor, and a grabber handling tool. The grabber handling tool may include a metal tube structure. The metal tube structure may be elongated. The elongated metal tube structure may have a first end and an opposite end. The first end may be configured for a user to hold. The opposite end may be configured to manipulate the safety chain assembly.

The grabber handling tool may further include a spring-loaded grabber. The spring-loaded grabber may be positioned at the opposite end of the metal tube structure. The spring-loaded grabber may be configured to grasp and release a chain hook of the safety chain assembly. An adjacent perpendicular member may be attached to the metal tube structure. The adjacent perpendicular member may have parallel elevated tracks that secure the hook when it is attached or detached. A locking pin mechanism may be incorporated into the grabber handling tool. The locking pin mechanism may be configured to secure the spring-loaded grabber in a closed position. The locking pin may rest over the adjacent perpendicular member. The locking pin may be designed for one-handed operation. The locking pin mechanism may be configured to maintain tension during chain manipulation. This configuration may enhance safety and efficiency by preventing accidental release or slackening of the safety chain during repositioning, attachment, or manipulation of the safety chain.

The loop bridge trailer securing system may be designed to provide ground level safety chain handling for hauling truck beds. This design may ensure user-friendly safety chain handling by allowing users to operate the system without climbing into the truck bed. The trailer mast anchor may be configured to securely fasten to a truck bed. The trailer mast anchor may also be configured to securely fasten a trailer mast to the truck bed. The trailer mast anchor may accomplish this by hooking to a secure bracing assembly of the trailer mast.

The loop bridge trailer securing system may include a loop bridge component. The loop bridge component may be separate from the grabber handling tool. The loop bridge component may be designed to elevate a spring-loaded loop in the truck bed. This elevation may allow for easier insertion of the chain hook into the loop. The loop bridge component may come in two different designs. One design may have notches and may be inserted from the side of the spring-loaded loop. Another design may slide in and set parallel with the loop. The choice between these designs may depend on the specific truck bed configuration and hitch design.

The notched loop bridge design may have left and right versions. These versions may be designed for specific placement in the truck bed. The notched design may fit a wider range of applications compared to the parallel design. The parallel loop bridge design may be useful for hitches with wider base parts that may swivel. This design may prevent potential damage to the loop bridge in certain hitch configurations. The loop bridge component may include optional height adjustment notches. These notches may allow for adaptation to various truck bed designs that require different loop height elevations.

The grabber handling tool and the loop bridge component may be designed to work together as a unit. This combination may allow for efficient and safe attachment and detachment of safety chains from ground level. A loop bridge trailer securing system may comprise a safety chain anchor, a trailer mast anchor loop bridge device, and a grabber handling tool. The grabber handling tool may comprise a metal tube structure embodied as an elongated member, a spring-loaded handle, a shaft cylinder, a front cylinder, a locking pin mechanism, a cable and rod loop, and a middle pin wherein the grabber handling tool is configured for use with a safety chain. In accordance with this disclosure, a grabber handling tool may comprise one or more of the following components:

A Metal Tube Structure: The metal tube structure is embodied as an elongated member. The grabber handling tool consists of this sturdy metal tube structure, designed for durability and ease of handling. The metal tube structure is configured to serve as the primary framework for the grabber handling tool safety chain manipulation device. The length of the metal tube structure is sufficient to allow a user to operate the grabber handling tool from ground level and successfully reach the necessary components of the truck bed.

A Spring-Loaded Grabber: The spring-loaded handle is positioned at one end of the metal tube structure. The grabber is configured to allow a user to reach and manipulate safety chain hooks without climbing into the truck bed. The spring-loaded grabber is configured such that when released, the spring ensures the grabber returns to its default position. The spring-loaded grabber is configured to allow a user to operate the grabber handling tool from ground level and successfully reach the necessary components of the truck bed.

An Adjacent Perpendicular Member having Parallel Elevated Tracks: Adjacent to the metal tube structure, there is an elongated member positioned perpendicular to the metal tube structure. The adjacent perpendicular member is configured such that it has two parallel elevated tracks on its side and a solid base portion between the two parallel elevated tracks. The adjacent perpendicular member is further configured to be closed on three sides and open on one side which is the top side. The adjacent perpendicular member is configured to houses the safety chain during operation.

A Locking Pin Mechanism: The locking pin is a crucial component. When the adjacent perpendicular member of the grabber handling tool is in an extended and/or open position, the locking pin secures it. During operation of the grabber handling tool, the locking pin allows users to unlock the tool for chain attachment or removal. The locking pin mechanism may also be described as the middle pin. This middle pin or locking pin that rests over the adjacent perpendicular member is positioned strategically. This strategic positioning allows, this middle pin or locking pin to maintain tension during chain manipulation. This enhances safety and efficiency by preventing accidental release or slackening of the chain during repositioning, attachment, or manipulation of the safety chain.

In one or more embodiments of the invention, the grabber handling tool comprises a metal tube structure, a spring-loaded grabber, an adjacent perpendicular member having parallel elevated safety panels, and a locking pin mechanism. The metal tube structure is embodied as an elongated member configured for a user to hold on one end and manipulate the safety chain using the components on the opposite end. The grabber handling tool comprising these aforementioned components combines practical design with innovative features, addressing the limitations of prior art while ensuring user-friendly safety chain handling.

Referring to FIG. 1, a grabber handling tool 100 of the loop bridge trailer securing system is shown. The grabber handling tool 100 comprises a metal tube structure 102, a spring-loaded grabber 104, an adjacent perpendicular member having parallel elevated safety panels 106, and a locking pin mechanism 108. The metal tube structure 102 is embodied as an elongated member configured for a user to hold on one end and manipulate the safety chain using the components on the opposite end 110A.

The metal tube structure 102 may be made of durable material such as steel, aluminum, or other suitable metals or composites that provide sufficient strength and rigidity for manipulating safety chains. The length of the metal tube structure 102 may be designed to allow a user standing on the ground beside a truck to reach the safety chains in the truck bed without climbing into the bed. In some embodiments, the metal tube structure 102 may have a length between approximately 3 feet and 6 feet, though other lengths may be used depending on the specific application.

The spring-loaded grabber 104 positioned at the opposite end 110A of the metal tube structure 102 may be configured to grasp and release chain hooks of a safety chain assembly. The spring-loaded grabber 104 may include a mechanism that allows it to open when pressure is applied and close automatically when pressure is released. This functionality enables the user to securely grasp a chain hook, manipulate it into position, and then release it once properly positioned.

The adjacent perpendicular member 106 may be attached to the metal tube structure 102 and may include parallel elevated safety panels. These panels may form tracks that secure the hook when it is being attached or detached. The adjacent perpendicular member 106 may be configured to be closed on three sides and open on the top side, creating a channel that can house the safety chain during operation.

The locking pin mechanism 108 may be configured to secure the spring-loaded grabber 104 in a closed position. The locking pin mechanism 108 may rest over the adjacent perpendicular member 106 and may be designed for one-handed operation. This configuration allows the user to maintain control of the grabber handling tool 100 while operating the locking mechanism. The strategic positioning of the locking pin mechanism 108 enables it to maintain tension during chain manipulation, enhancing safety and efficiency by preventing accidental release or slackening of the safety chain during repositioning, attachment, or manipulation.

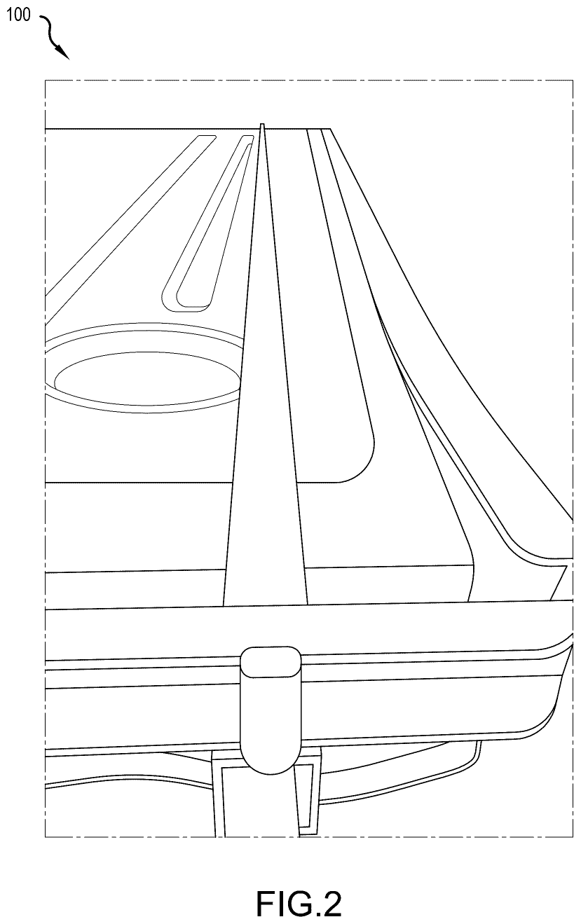

Referring to FIG. 2, the grabber handling tool 100 is shown laying face up on the tailgate of the truck with the grabber in a closed position. The trailer mast anchor 515 functions as a loop bridge device. The loop bridge device is designed to be positioned under a spring-loaded loop in the truck bed to which the chain hook is inserted for attaching the safety chains to the truck. Without this loop bridge device, the spring-loaded loop would be pressed down against the floor of the truck bed, making it difficult or impossible to attach the hook into the loop. The loop bridge device elevates the loop to a proper height to allow for insertion of the chain hook.

The loop bridge device may be designed to be inserted under the loop and can remain in place for convenient access each time the chains need to be attached or detached from the loop. In some embodiments, the loop bridge device may include optional height adjustment notches, which accommodate trucks with various bed designs requiring different loop height elevations. The trailer mast anchor 515 may feature two parts: one piece parallel to the truck bed with a groove sized to receive a second piece with an opening that forms a loop sized to receive the chains. This two-part design allows for flexibility in installation and use across different truck bed configurations.

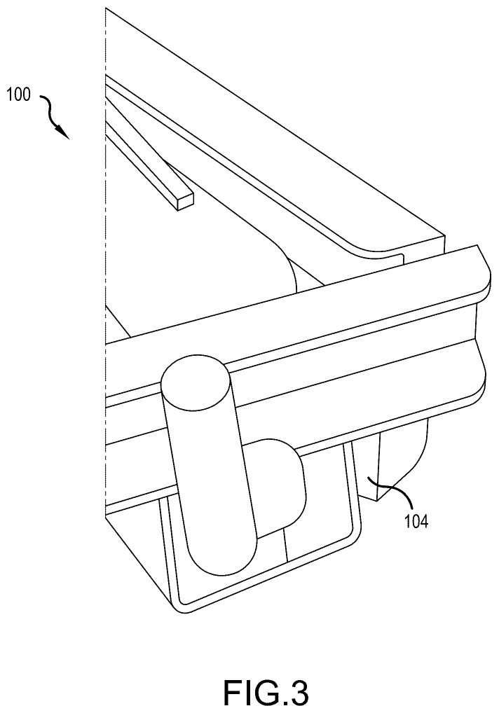

FIG. 3 shows the grabber handling tool 100 with the spring-loaded grabber 104 depressed, illustrating how the spring mechanism loads when pressure is applied. This depressed position allows the grabber to open and grasp a chain hook. When the pressure is released, the spring returns the grabber to its closed position, securing the hook for manipulation.

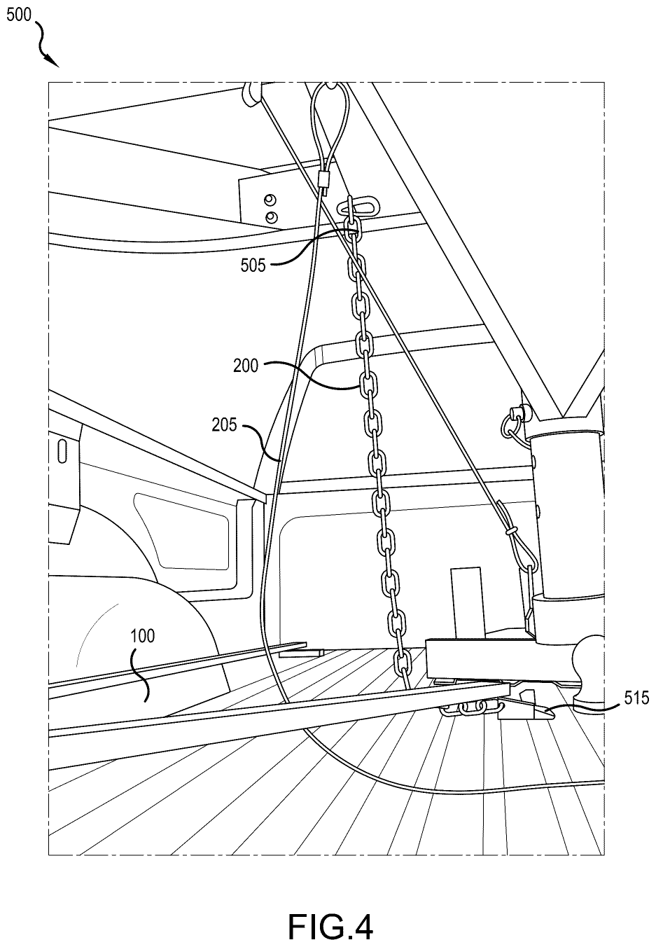

Referring to FIG. 4, the grabber handling tool 100 is shown in operation, connected to at least a portion of a safety chain 200 and cable 205. The figure also shows a safety chain assembly 505 and a trailer mast anchor 515. This illustration demonstrates how the grabber handling tool 100 interfaces with the safety chain components during the attachment or detachment process.

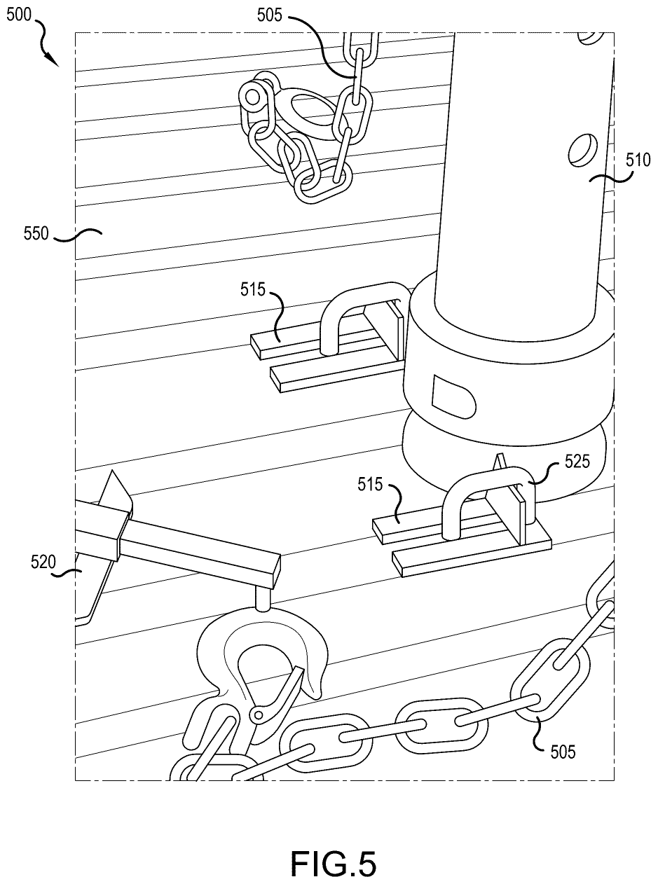

FIG. 5 provides a comprehensive view of the loop bridge trailer securing system 500, showing a safety chain assembly 505, a trailer mast anchor 515 on a vehicle hitch 510, a safety chain grabber tool 520, and a truck bed 550. The system is configured such that the trailer mast anchor 515 can securely fasten to the truck bed 550 or to a vehicle hitch 510 on the truck bed. The trailer mast anchor 515 can securely fasten the hitch 510 to the truck bed 550 by hooking to a secure bracing assembly 525 of the trailer mast.

In some embodiments, the loop bridge device may come in two different designs. One design may have notches and may be inserted from the side of the spring-loaded loop. This notched design may be available in left and right versions for specific placement in the truck bed and may fit a wider range of applications compared to other designs. Another design may slide in parallel with the loop and set in place. This parallel design may be particularly useful for hitches with wider base parts that may swivel, preventing potential damage to the loop bridge in certain hitch configurations.

In one or more embodiments, the loop bridge trailer securing system provides several advantages over conventional trailer securing methods. By allowing users to perform safety chain operations from ground level, it eliminates the need to climb into the truck bed, reducing the risk of strain injuries or accidents. The system enhances efficiency by streamlining the process of attaching, detaching, and reattaching safety chains. Additionally, the locking pin mechanism maintains tension during chain manipulation, preventing accidental release or slackening and thereby enhancing safety during towing operations. The loop bridge trailer securing system may be used in various applications where trailers or RVs are towed by trucks. It may be particularly beneficial for commercial operations where frequent trailer connections and disconnections are required, as well as for recreational users who may have limited mobility or strength.

### Technical Advantages

In one or more embodiments, the loop bridge trailer securing system provides several technical advantages over conventional trailer securing methods. One significant advantage is the elimination of the need for users to climb into the truck bed to attach, detach, or manipulate safety chains. This ground-level operation capability substantially reduces the risk of falls, strains, and injuries that commonly occur when users must climb into truck beds, particularly in adverse weather conditions or for users with limited mobility. In one or more embodiments, the strategic design of the grabber handling tool with its elongated metal tube structure enables users to reach and manipulate safety chains from a safe distance. This extended reach capability provides ergonomic benefits by reducing physical strain on users who would otherwise need to stretch, bend, or contort their bodies to access safety chains in truck beds. The spring-loaded grabber mechanism at the opposite end of the metal tube structure offers precise control over chain hook manipulation, allowing for more accurate and controlled attachment and detachment operations.

In one or more embodiments, the adjacent perpendicular member with parallel elevated tracks provides a crucial technical advantage by creating a guided pathway for the safety chain during manipulation. This guided pathway significantly reduces the likelihood of chain tangling or misalignment during attachment or detachment procedures. The three-sided closed design with an open top allows for easy insertion and removal of the chain while maintaining lateral stability during operation.

In one or more embodiments, a particularly innovative technical advantage is found in the locking pin mechanism that rests over the adjacent perpendicular member. This mechanism maintains tension during chain manipulation, which substantially enhances operational safety by preventing accidental release or slackening of the safety chain during repositioning, attachment, or manipulation. The one-handed operation capability of this locking pin mechanism allows users to maintain control of the grabber handling tool with one hand while operating the locking mechanism with the other, improving overall operational efficiency.

In one or more embodiments, the trailer mast anchor component of the system provides dual functionality by serving both as a secure fastening point for the trailer mast and as a loop bridge device. This dual functionality reduces the number of separate components needed in the truck bed, thereby simplifying the overall system. The elevation of the spring-loaded loop in the truck bed through the use of the loop bridge component addresses a critical technical challenge in traditional systems where the spring-loaded loop is often pressed against the truck bed floor, making hook insertion difficult or impossible.

The availability of different loop bridge designs (notched and parallel) provides technical adaptability to various truck bed configurations and hitch designs. This adaptability ensures broader compatibility across different vehicle models and trailer types. The optional height adjustment notches in the loop bridge component further enhance this adaptability by accommodating trucks with various bed designs that require different loop height elevations.

The system's integrated design, where components work together as a coordinated unit, provides synergistic advantages that exceed the benefits of individual components. The grabber handling tool and loop bridge component work in tandem to create an efficient chain attachment and detachment system that operates from ground level. This integration results in faster, safer, and more reliable trailer securing operations.

From a materials engineering perspective, the use of sturdy metal construction for the tube structure ensures durability and longevity under repeated use and exposure to various environmental conditions. The spring mechanism in the grabber is designed to maintain consistent tension and return to its default position reliably, enhancing operational consistency and reducing the likelihood of mechanical failure.

In summary, the loop bridge trailer securing system represents a significant technical advancement over conventional trailer securing methods by addressing safety concerns, improving ergonomics, enhancing operational efficiency, and providing adaptability across different vehicle configurations. These technical advantages collectively result in a system that not only improves user experience but also enhances the overall safety and reliability of trailer securing operations.

In one or more embodiments, the spring-loaded grabber at the opposite end of the metal tube structure may be configured to grasp and release a chain hook of the safety chain assembly. The spring-loaded grabber may include a front portion and a rear portion. The front portion may be configured to directly contact the chain hook. The rear portion may be connected to a spring mechanism housed within the metal tube structure. The spring mechanism may provide tension to maintain the grabber in a closed position when not actively being operated by a user.

In one or more embodiments, the adjacent perpendicular member may be constructed of a durable metal material similar to the metal tube structure. The parallel elevated tracks of the adjacent perpendicular member may be configured with specific dimensions to accommodate standard safety chain hooks. These dimensions may vary slightly between different models of the loop bridge trailer securing system to accommodate different sizes of safety chain hooks commonly used in the industry. The solid base portion between the two parallel elevated tracks may provide structural support and prevent the chain hook from slipping during manipulation.

In one or more embodiments, the locking pin mechanism may include a pin shaft that extends through a portion of the grabber handling tool. The pin shaft may be connected to a handle or lever accessible to the user. The handle or lever may be positioned for ergonomic one-handed operation. When engaged, the locking pin mechanism may physically block the spring-loaded grabber from opening, thereby maintaining a secure grip on the chain hook during manipulation. The locking pin mechanism may be disengaged with a simple motion of the user's thumb or finger when release of the chain hook is desired.

In one or more embodiments, the trailer mast anchor may be constructed of high-strength materials capable of withstanding significant tensile forces. The trailer mast anchor may be configured with mounting holes or slots that align with standard truck bed attachment points. These mounting points may allow for secure fastening using bolts, screws, or other appropriate fasteners. The trailer mast anchor may include reinforced areas at points of high stress to prevent deformation under load.

In one or more embodiments, the loop bridge component of the trailer mast anchor may be available in multiple configurations to accommodate different truck bed designs. The notched loop bridge design may include specific cut-out sections that allow it to be inserted from the side of the spring-loaded loop. These notches may be precisely sized to fit around standard loop mounting hardware while providing sufficient clearance for operation. The parallel loop bridge design may have a smooth profile that slides in parallel with the loop, avoiding any potential interference with wider hitch base parts that may swivel during operation.

In one or more embodiments, the optional height adjustment notches on the loop bridge component may be spaced at regular intervals. These intervals may be determined based on common truck bed configurations and the range of height adjustments typically needed. Each notch may provide a stable resting position for the loop bridge component, ensuring that the elevated loop remains at the proper height during chain hook insertion or removal.

In one or more embodiments, the safety chain assembly may include standard safety chains commonly used for trailer attachment. The safety chain assembly may be compatible with the grabber handling tool and the trailer mast anchor. The safety chain assembly may include hooks at one or both ends for secure attachment. The hooks may be designed to be easily grasped by the spring-loaded grabber of the grabber handling tool.

In one or more embodiments, the metal tube structure of the grabber handling tool may be constructed of lightweight yet durable materials such as aluminum or steel alloy. The length of the metal tube structure may be sufficient to allow a user standing at ground level to reach the safety chain attachment points in the truck bed. The diameter of the metal tube structure may be optimized for comfortable gripping by users with a range of hand sizes. The surface of the metal tube structure may include texturing or coating to provide improved grip, particularly in wet or cold conditions.

In one or more embodiments, the first end of the metal tube structure may include an ergonomic handle or grip. This handle or grip may be contoured to fit comfortably in the user's hand. The handle or grip may be made of a different material than the main tube, such as rubber or textured plastic, to provide improved comfort and grip. The opposite end of the metal tube structure may include mounting points for the spring-loaded grabber, adjacent perpendicular member, and locking pin mechanism.

In one or more embodiments, the spring-loaded grabber may be pivotally mounted to the opposite end of the metal tube structure. The pivotal mounting may allow the grabber to move between open and closed positions. The spring mechanism may apply force to maintain the grabber in a closed position when not actively being opened by the user. The spring tension may be calibrated to provide sufficient gripping force to securely hold a chain hook without requiring excessive force from the user to open the grabber.

In one or more embodiments, the grabber handling tool may include a cable or rod connected to the spring-loaded grabber. This cable or rod may extend through the metal tube structure to the first end, allowing the user to control the grabber from the handle end. The cable or rod may be protected within the metal tube structure to prevent damage or interference with operation. The connection between the cable or rod and the spring-loaded grabber may be designed to provide smooth and reliable operation over many cycles of use.

In one or more embodiments, the loop bridge trailer securing system may be designed to accommodate a range of truck bed heights and configurations. The system may function effectively with both standard and custom truck bed installations. The system may be compatible with various trailer hitch designs, including standard ball hitches, fifth-wheel hitches, and gooseneck hitches. The system may be designed to work with trailers of various sizes and weights, from small utility trailers to large recreational vehicles.

In one or more embodiments, the trailer mast anchor may include features that prevent unintended movement or shifting during use. These features may include anti-slip surfaces, locking mechanisms, or geometric designs that mechanically resist movement when under load. The trailer mast anchor may be designed to distribute forces evenly across its mounting points to prevent concentrated stress that could lead to failure.

In one or more embodiments, the grabber handling tool may be designed for durability in various environmental conditions. The materials and finishes used in the grabber handling tool may resist corrosion from exposure to moisture, road salt, and other potential contaminants. The mechanical components of the grabber handling tool may be designed to function reliably across a wide temperature range, from below freezing to high summer temperatures.

In one or more embodiments, the loop bridge component may be designed for easy installation and removal when needed. The loop bridge component may include features that allow it to be quickly positioned under the spring-loaded loop in the truck bed. These features may include tapered edges, guide surfaces, or other design elements that facilitate proper positioning. The loop bridge component may be designed to remain securely in place once installed, even when subjected to vibration or movement during vehicle operation.

In one or more embodiments, the loop bridge trailer securing system may include visual indicators or markings that help users properly align and position the components during use. These indicators may include color coding, alignment marks, or other visual cues that simplify the process of connecting and disconnecting safety chains. The system may be designed with consideration for users with varying levels of physical strength and dexterity, allowing for operation by a wide range of individuals.

In one or more embodiments, the safety chain assembly may be constructed of materials that meet or exceed industry standards for strength and durability. The chain links may be sized appropriately for the intended load capacity. The hooks or other attachment hardware may be designed to prevent accidental disconnection during use. The safety chain assembly may include features that prevent tangling or kinking during storage and use.

In one or more embodiments, the trailer mast anchor may be designed to work in conjunction with standard trailer mast designs. The trailer mast anchor may include features that align with common trailer mast configurations to ensure proper fit and function. The trailer mast anchor may be adjustable to accommodate variations in trailer mast dimensions or positioning. The trailer mast anchor may include features that prevent unintended disconnection of the trailer mast during use.

In one or more embodiments, the grabber handling tool may be designed for easy storage when not in use. The grabber handling tool may include features such as hanging hooks, mounting brackets, or other storage solutions that allow it to be conveniently stored in a truck, garage, or workshop. The grabber handling tool may be designed to minimize the space required for storage while remaining readily accessible when needed.

In one or more embodiments, the loop bridge trailer securing system may be manufactured using processes that ensure consistent quality and performance. The components may be subject to quality control measures that verify proper dimensions, material properties, and functional performance. The system may be tested under simulated use conditions to ensure reliability and durability over time. The manufacturing processes may be designed to minimize variations that could affect the function or safety of the system.

In one or more embodiments, the loop bridge component may be available in different sizes to accommodate various truck bed and hitch configurations. The selection of the appropriate size may be based on measurements of the specific truck bed and hitch setup. The loop bridge component may include adjustment features that allow fine-tuning of its position or height to ensure optimal performance with a specific truck and trailer combination.

In one or more embodiments, the grabber handling tool may include a shaft cylinder and a front cylinder as part of its construction. The shaft cylinder may house internal components such as the cable or rod that controls the spring-loaded grabber. The front cylinder may provide structural support and protection for the spring-loaded grabber mechanism. These cylindrical components may be designed for strength while minimizing overall weight of the tool. In one or more embodiments, the cable and rod loop mentioned in the system description may be part of the mechanism that connects the user's input at the handle end to the action of the spring-loaded grabber at the opposite end. This cable and rod loop may be designed for smooth operation with minimal friction. The cable and rod loop may be protected within the metal tube structure to prevent damage or contamination that could affect performance. In one or more embodiments, the middle pin mentioned in the system description may be another term for the locking pin mechanism. This middle pin may be positioned to interact with both the adjacent perpendicular member and the spring-loaded grabber mechanism. The position of the middle pin may be critical for proper function of the locking mechanism and maintenance of tension during chain manipulation.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications can be referenced. The disclosures of these publications in their entirety are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein can be different from the actual publication dates, which can require independent confirmation.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure. Insofar as the description above and the accompanying drawing disclose any additional subject matter that is not within the scope of the claims below, the disclosures are not dedicated to the public and the right to file one or more applications to claims such additional disclosures is reserved. Although very narrow claims are presented herein, it should be recognized the scope of this disclosure is much broader than presented by the claims. It is intended that broader claims will be submitted in an application that claims the benefit of priority from this application.

The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. A loop bridge trailer securing system comprising:
a safety chain assembly;
a trailer mast anchor configured to elevate a spring-loaded loop in a truck bed to allow for insertion of a chain hook into the loop; and
a grabber handling tool comprising:
an elongated metal tube structure having a first end configured for a user to hold and an opposite end;
a spring-loaded grabber positioned at the opposite end of the metal tube structure and configured to grasp and release a chain hook of the safety chain assembly;
an adjacent perpendicular member attached to the metal tube structure and having parallel elevated tracks configured to secure the chain hook during manipulation; and
a locking pin mechanism configured to secure the spring-loaded grabber in a closed position.

2. The loop bridge trailer securing system of claim 1, wherein the locking pin mechanism rests over the adjacent perpendicular member.

3. The loop bridge trailer securing system of claim 1, wherein the locking pin mechanism is designed for one-handed operation.

4. The loop bridge trailer securing system of claim 1, wherein the locking pin mechanism is configured to maintain tension during chain manipulation, thereby preventing accidental release or slackening of the safety chain assembly.

5. The loop bridge trailer securing system of claim 1, wherein the trailer mast anchor comprises two parts: a first piece configured to be positioned parallel to the truck bed with a groove, and a second piece configured to be received in the groove of the first piece, the second piece having an opening that forms a loop sized to receive chains of the safety chain assembly.

6. The loop bridge trailer securing system of claim 1, wherein the trailer mast anchor is available in a notched design that inserts from a side of the spring-loaded loop.

7. The loop bridge trailer securing system of claim 6, wherein the notched design is available in left and right versions for specific placement in the truck bed.

8. The loop bridge trailer securing system of claim 1, wherein the trailer mast anchor is available in a parallel design that slides in and sets.

9. The loop bridge trailer securing system of claim 1, wherein the trailer mast anchor includes height adjustment notches for adaptation to various truck bed designs.

10. The loop bridge trailer securing system of claim 1, wherein the trailer mast anchor is configured to securely fasten a trailer mast to the truck bed by hooking to a secure bracing assembly of the trailer mast.

11. A method for securing a trailer to a truck bed, the method comprising:
positioning a trailer mast anchor in a truck bed to elevate a spring-loaded loop;
grasping a chain hook of a safety chain assembly using a spring-loaded grabber of a grabber handling tool;
maneuvering the chain hook to the elevated spring-loaded loop using the grabber handling tool; and
inserting the chain hook into the elevated spring-loaded loop;
wherein the grabber handling tool comprises:
an elongated metal tube structure having a first end configured for a user to hold and an opposite end;
the spring-loaded grabber positioned at the opposite end of the metal tube structure;
an adjacent perpendicular member attached to the metal tube structure and having parallel elevated tracks configured to secure the chain hook during manipulation; and
a locking pin mechanism configured to secure the spring-loaded grabber in a closed position.

12. The method of claim 11, wherein the locking pin mechanism is designed for one-handed operation.

13. The method of claim 11, wherein the locking pin mechanism is configured to maintain tension during chain manipulation, thereby preventing accidental release or slackening of the safety chain assembly.

14. The method of claim 11, wherein the trailer mast anchor comprises two parts: a first piece positioned parallel to the truck bed with a groove, and a second piece received in the groove of the first piece, the second piece having an opening that forms a loop sized to receive chains of the safety chain assembly.

15. A trailer mast anchor for a loop bridge trailer securing system, the trailer mast anchor comprising:
a first piece configured to be positioned parallel to a truck bed, the first piece having a groove; and
a second piece configured to be received in the groove of the first piece, the second piece having an opening that forms a loop sized to receive chains of a safety chain assembly;
wherein the trailer mast anchor is configured to elevate a spring-loaded loop in the truck bed to allow for insertion of a chain hook into the loop.

16. The trailer mast anchor of claim 15, wherein the trailer mast anchor is available in a notched design that inserts from a side of the spring-loaded loop.

17. The trailer mast anchor of claim 15, wherein the trailer mast anchor is available in a parallel design that slides in and sets.

18. The trailer mast anchor of claim 15, wherein the trailer mast anchor includes height adjustment notches for adaptation to various truck bed designs.

19. The trailer mast anchor of claim 15, wherein the trailer mast anchor is configured to securely fasten a trailer mast to the truck bed by hooking to a secure bracing assembly of the trailer mast.

20. The trailer mast anchor of claim 16, wherein the notched design is available in left and right versions for specific placement in the truck bed.
